(19) United States
(12) Patent Application Publication
(10) Pub. No.: US 2004/0192443 A1
(43) Pub. Date: Sep. 30, 2004

(54) Amusement device communication system

(75) Inventors: James R. Stelzer, Bensalem, PA (US); Scott Ferguson, Levittown, PA (US); Michael Abbate, Vineland, NJ (US)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(73) Assignee: Merit Industries, Inc.

(21) Appl. No.: 10/789,467

(22) Filed: Feb. 27, 2004

Related U.S. Application Data
(60) Provisional application No. 60/457,228, filed on Mar. 24, 2003.

(51) Int. Cl. A63F 13/00

(52) U.S. Cl. 463/42

(57) ABSTRACT

Amusement device communication system includes a communication link, a first amusement device and a second amusement device. The communication link has a communication medium and a power line communication subsystem. The first amusement device has a video touchscreen, and the second amusement device has a controller and a memory. The second amusement device is coupled to the first amusement device by the communication link, and the first amusement device communicates with the second amusement device using the communication medium. The power line communication sub-system includes a local power grid and first and second power line adapters. The local power grid is configured to supply electrical power to local devices. The first power line adapter is coupled between the first amusement device and the local power grid. The first adapter superimposes communication signals onto the local power grid and decodes superimposed communication signals from the local power grid.

### CROSS-REFERENCE TO RELATED APPLICATIONS

This non-provisional patent application is based on Provisional Patent Application No. 60/457,228, filed Mar. 24, 2003, entitled “Amusement Device Communication System.”

### BACKGROUND OF THE INVENTION

The present invention relates generally to an amusement device communication system and, more particularly, relates to an amusement device communication system using power lines, telephone lines or wireless communications.

Amusement devices, such as game machines, which allow a user to select game choices from a video display are well-known in the art such as those disclosed in U.S. Pat. No. 4,856,787 (Itkis), U.S. Pat. No. 5,575,717 (Houriet, Jr. et al.), and U.S. Pat. No. 5,743,799 (Houriet, Jr. et al.), the contents of which are incorporated by reference herein, each of which shows a touch screen display for making a game selection from a menu of games. Such game machines typically operate upon input of currency (i.e., coin, token, paper money, credit/debit cards and the like) and are installed in bars, restaurants, airports, shopping malls and the like. The game choices may include card games, sports games, games of skill, games of chance, action games and the like.

In some instances, such games are configured to be played either against another competitor or in a competition or tournament. In more advanced systems, the game machines are connected either peer to peer by a direct cable connection or in a hardwired network, such as a hardwired local area network (LAN), allowing a player at one game machine to play against a competitor at a different game machine or to participate in a competition or tournament that tracks players at a plurality of game machines.

Such a game machine communication system requires that network cabling, in addition to the power supply cabling, be run between game machines and network hubs, routers, modems and/or gateways and the like. Dedicated network cabling can be difficult to install in an existing building and may require additional expense to install. Further, in the event that the owner wants to relocate the game machine or machines within a site location, there is limited flexibility because the game machines must be connected to a hardwired network access point.

What is needed but not presently provided by the prior art devices is an amusement device communication system able to use existing power lines for inter-device communication. Further, what is needed but not provided by the prior art devices is an amusement device communication system able to use existing telephone lines for inter-device communication. Even further, what is needed but not provided by the prior art devices is an amusement device communication system able to communicate wirelessly.

### BRIEF SUMMARY OF THE INVENTION

Briefly stated, the present invention comprises an amusement device communication system. The amusement device communication system includes a communication link, a first amusement device and a second amusement device. The communication link has a communication medium and a power line communication subsystem. The first amusement device has a video touchscreen, and the second amusement device has a controller and a memory. The second amusement device is coupled to the first amusement device by the communication link, and the first amusement device communicates with the second amusement device using the communication medium. The power line communication sub-system includes a local power grid, a first power line adapter and a second power line adapter. The local power grid is configured to supply electrical power to local devices. The first power line adapter is coupled between the first amusement device and the local power grid. The first power line adapter superimposes communication signals onto the local power grid and decodes superimposed communication signals from the local power grid. The second power line adapter is coupled between the second amusement device and the local power grid. The second power line adapter superimposes communication signals onto the local power grid and decodes superimposed communication signals from the local power grid.

The present invention also comprises another amusement device communication system. The amusement device communication system includes a communication link, a first amusement device and a second amusement device. The communication link has a communication medium and a wireless sub-system. The first amusement device has a video touchscreen, and the second amusement device has a controller and a memory. The second amusement device is coupled to the first amusement device by the communication link. The first amusement device communicates with the second amusement device using the communication medium. The wireless sub-system includes a first wireless adapter and a second wireless adapter. The first wireless adapter is coupled to the first amusement device. The first wireless adapter encodes communication signals onto a wireless broadcast signal and decodes communication signals from the wireless broadcast signal. The second wireless adapter is coupled to the second amusement device. The second wireless adapter encodes communication signals onto the wireless broadcast signal and decodes communication signals from the wireless broadcast signal.

The present invention also comprises yet another amusement device communication system. The amusement device communication system includes a communication link, a first amusement device and a second amusement device. The communication link has a communication medium and a telephone line communication subsystem. The first amusement device has a video touchscreen. The second amusement device has a controller and a memory. The second amusement device is coupled to the first amusement device by the communication link. The first amusement device communicates with the second amusement device using the communication medium. The telephone line communication sub-system includes a local telephone grid, a first telephone line adapter and a second telephone line adapter. The local telephone grid is configured to supply standard telephonic signals to local telephones. The first telephone line adapter is coupled between the first amusement device and the local telephone grid. The first telephone line adapter superimposes communication signals onto the local telephone grid and decodes superimposed communication signals from the local telephone grid. The second telephone line adapter is coupled between the second amusement device and the local telephone grid. The second telephone line adapter superimposes communication signals onto the local telephone grid and decodes superimposed communication signals from the local telephone grid.

The present invention further comprises yet another amusement device communication system. The amusement device communication system includes a communication link and first, second and third amusement devices. The communication link has a communication medium and a power line communication subsystem. The first and third amusement devices each have a video touchscreen and a controller. The second amusement device has an audio output, a controller and a memory configured to store and retrieve music files. The second amusement device is coupled to the first and third amusement devices by the communication link. The first and third amusement devices communicate with the second amusement device using the communication medium. The video touchscreen of the first and third amusement devices are each configured to access the controller of the second amusement device to cause the controller of the second amusement device to retrieve one of the music files and output the retrieved music file to the audio output of the second amusement device. The power line communication sub-system includes a local power grid and first, second and third power line adapters. The local power grid is configured to supply electrical power to local devices. The first power line adapter is coupled between the first amusement device and the local power grid. The first power line adapter superimposes communication signals onto the local power grid and decodes superimposed communication signals from the local power grid. The second power line adapter is coupled between the second amusement device and the local power grid. The second power line adapter superimposes communication signals onto the local power grid and decodes superimposed communication signals from the local power grid. The third power line adapter is coupled between the third amusement device and the local power grid. The third power line adapter superimposes communication signals onto the local power grid and decodes superimposed communication signals from the local power grid.

The present invention further comprises yet another amusement device communication system. The amusement device communication system includes a communication link and first, second and third amusement devices. The communication link has a communication medium and a wireless communication subsystem. The first and third amusement devices each have a video touchscreen and a controller. The second amusement device has an audio output, a controller and a memory configured to store and retrieve music files. The second amusement device is coupled to the first and third amusement devices by the communication link. The first and third amusement devices communicate with the second amusement device using the communication medium. The video touchscreen of the first and third amusement devices are each configured to access the controller of the second amusement device to cause the controller to retrieve one of the music files and output the retrieved music file to the audio output of the second amusement device. The wireless communication sub-system includes first, second and third wireless adapters. The first wireless adapter is coupled to the first amusement device. The first wireless adapter encodes communication signals onto a wireless broadcast signal and decodes communication signals from the wireless broadcast signal. The second wireless adapter is coupled to the second amusement device. The second wireless adapter encodes communication signals onto the wireless broadcast signal and decodes communication signals from the wireless broadcast signal. The third wireless adapter is coupled to the third amusement device. The third wireless adapter encodes communication signals onto the wireless broadcast signal and decodes communication signals from the wireless broadcast signal.

The present invention further comprises yet another amusement device communication system. The amusement device communication system includes a communication link and first, second and third amusement devices. The communication link has a communication medium and a telephone line communication subsystem. The first and third amusement devices each have a video touchscreen and a controller. The second amusement device has an audio output, a controller and a memory configured to store and retrieve music files. The second amusement device is coupled to the first and third amusement devices by the communication link. The first and third amusement devices communicate with the second amusement devices using the communication medium. The video touchscreen of the first and third amusement devices are each configured to access the controller of the second amusement device to cause the controller of the second amusement device to retrieve one of the music files and output the retrieved music file to the audio output of the second amusement device. The telephone line communication sub-system includes a local telephone grid and first, second and third telephone line adapters. The local telephone grid is configured to supply standard telephonic signals to local telephones. The first telephone line adapter is coupled between the first amusement device and the local telephone grid. The first telephone line adapter superimposes communication signals onto the local telephone grid and decodes superimposed communication signals from the local telephone grid. The second telephone line adapter is coupled between the second amusement device and the local telephone grid. The second telephone line adapter superimposes communication signals onto the local telephone grid and decodes superimposed communication signals from the local telephone grid. The third telephone line adapter is coupled between the third amusement device and the local telephone grid. The third telephone line adapter superimposes communication signals onto the local telephone grid and decodes superimposed communication signals from the local telephone grid.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 is a is a block diagram of an amusement device communication system in accordance with a first preferred embodiment of the present invention;

FIG. 2 is a block diagram of an amusement device communication system in accordance with a second preferred embodiment of the present invention;

FIG. 3 is a block diagram of an amusement device communication system in accordance with a third preferred embodiment of the present invention;

FIG. 4 is a block diagram of an amusement device communication system in accordance with a fourth preferred embodiment of the present invention; and

FIG. 5 is a block diagram of an amusement device communication system in accordance with a second preferred embodiment of the present invention.

### DETAILED DESCRIPTION OF THE INVENTION

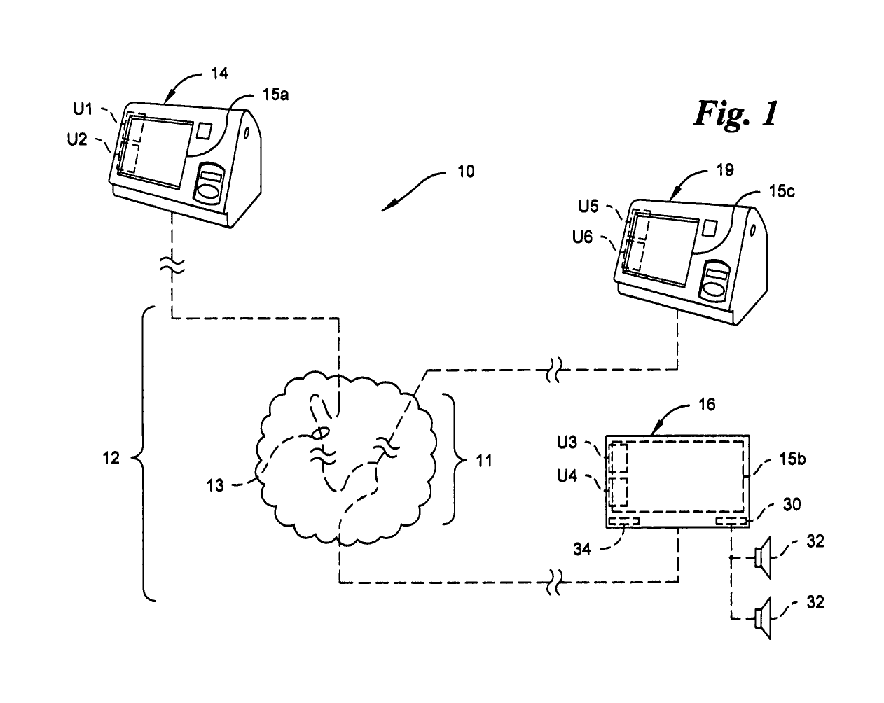

In the drawings, like numerals are used to indicate like elements throughout. Referring to the drawings in detail, FIG. 1 shows a first preferred embodiment of an amusement device communication system 10. The amusement device communication system 10 includes a communication link 12, a first amusement device 14, a second amusement device 16 and a third amusement device 19. The communication link 12 has a communication medium 13 and a communication hardware subsystem 11. The communication medium 13 may either be a new or existing hardware layer having some form of carrier signal, such as power lines or telephone lines, or the communication medium may be the surrounding environment as in the case of a wireless communications configuration. Preferably, the communication link 12 does not require additional communication wire to be run between amusement devices 14, 16, 19, other than a short jumper wire between the amusement device 14, 16, 19 and an adapter of some variety as will be described in greater detail hereinafter.

The first amusement device 14 has a video touchscreen 15a, a controller U1 and a memory U2. The second amusement device 16 has a controller U3 and a memory U4. The second amusement device 16 may optionally include a video display or video touchscreen 15b. The third amusement device 19 has a video touchscreen 15c, a controller U5 and a memory U6. The second amusement device 16 is coupled to the first amusement device 14 and the third amusement device 19 by the communication link 12, and the first amusement device 14 and the third amusement device 19 communicate with the second amusement device 16 using the communication medium 13, and vice versa. Likewise, the third amusement device 19 is coupled to the first amusement device 14 for communicating using the communication medium 13, and vice versa, as well. Preferably, communications between the first, second and third amusement devices 14, 16 and 19 is bidirectional, but need not be. Furthermore, the amusement device communication system 10, as shown, links three amusement devices 14, 16, 19, but the amusement device communication system 10 could link a greater number of amusement devices as would be clearly recognized by one skilled in the art.

The second amusement device 16 may also include an audio output 30 configured to drive a speaker or speakers 32. The audio output 30 may alternatively be connected to an audio amplifier, a stereo or other type of sound system (not shown). The memory U4 of the second amusement device 16 is configured to store and retrieve music files. The controller U3 of the second amusement device 16 is configured to access the memory U4 of the second amusement device 16 to retrieve one of the music files and output the retrieved music file to the audio output 30. Preferably, the memory U4 of the second amusement device 16 is capable of storing a large number of music files. The memory U4 of the second amusement device 16 may be a flash random access memory (RAM), a read only memory (ROM), a disk or diskette drive, a compact disk read only memory (CDROM), a digital video disc (DVD), a tape/tape drive, an optical drive and the like. The second amusement device 16 may further include a video output 34. The memory U4 of the second amusement device 16 is configured to store and retrieve multimedia files. The controller U3 of the second amusement device 16 is configured to access the memory U3 of the second amusement device 16 to retrieve one of the multimedia files and output the retrieved multimedia file to both the audio and video outputs 30, 34, respectively. Thus, the second amusement device 16 can be a stand alone music source, jukebox or video jukebox which is accessible by the other amusement devices 14 and 19 via the communications link 12. The first and second amusement devices 14 and 19 may be existing touchscreen video game-type machines which communicate with the second amusement device 16 (i.e., the jukebox) to allow a user to view the list of music and/or video files stored in the second amusement device 16 and to select a music and/or video file to be played by the second amusement device 16.

The second amusement device 16 may be a “blind” device (i.e., having no local video display or video touchscreen) that is connected to a site sound system. Thus, a new or existing site having one or more new or existing amusement devices 14, 19 can easily add the functionality of a music and/or video jukebox without additional floor space by using the amusement devices 14, 19 to function as the “front-end” user interface to the second amusement device 16 which can be located in a remote or concealed location such as an audio/visual equipment closet and the like.

It is contemplated that the second amusement device 16 could also function as a game “file server” storing a large variety of different games which are also accessible by the other amusement devices 14, 19.

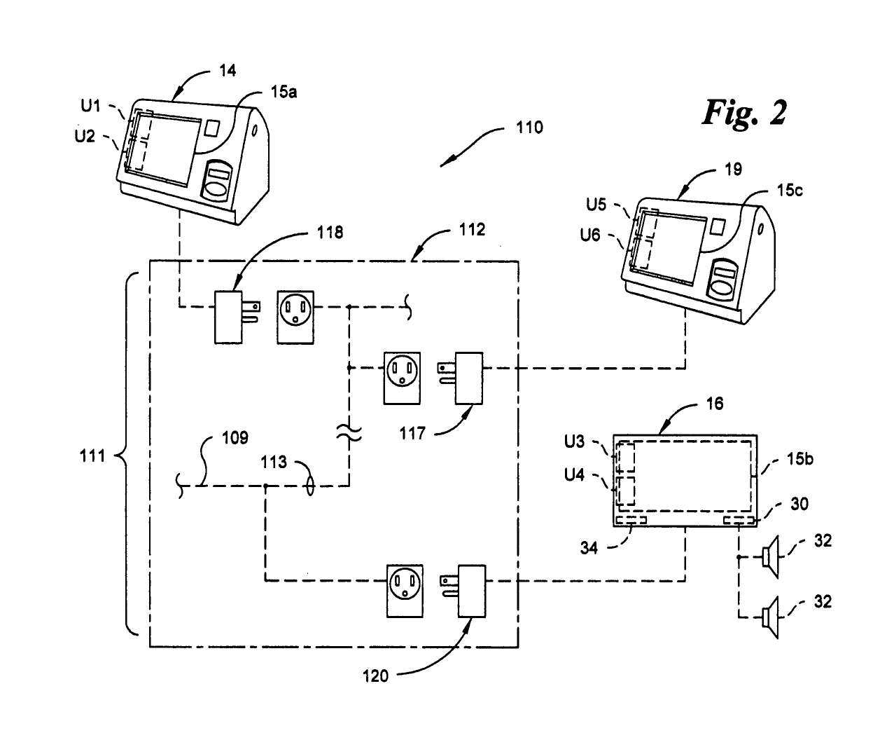

Referring to FIG. 2, there is shown a second preferred embodiment of an amusement device communication system 110. The amusement device communication system 110 includes a communication link 112 which links the first amusement device 14, the second amusement device 16 and the third amusement device 19 in a fashion similar to the first preferred embodiment. The communication link 112 has a communication medium 113 and a power line communication subsystem 111. The power line communication sub-system 111 includes a local power grid 109, a first power line adapter 118, a second power line adapter 120 and a third power line adapter 117. The local power grid 109 is configured to supply electrical power to local devices, such as lights, appliances and the like. Preferably, the local power grid 109 supplies 120 VAC, 60 Hz, single phase electrical power (i.e., voltage and current). Of course, the local power grid 109 could be configured to supply other voltages at other frequencies, such as 230 VAC, 50 Hz, single phase electrical voltage, with out departing from the broad inventive scope of the present invention. In the presently preferred embodiment, the communication medium 113 amounts to the electrical supply voltage on the local power grid 109 because, as will be described hereafter, the first, second and third power line adapters 118, 120, and 117 superimpose signals onto the electrical voltage which acts as a carrier signal. But, the communication medium 113 could be construed as including the local power grid 109 without departing from the present invention. The first power line adapter 118 is coupled between the first amusement device 14 and the local power grid 109. The first power line adapter 118 superimposes communication signals onto the local power grid 109 and decodes superimposed communication signals from the local power grid 109. The second power line adapter 120 is coupled between the second amusement device 16 and the local power grid 109. The second power line adapter 120 superimposes communication signals onto the local power grid 109 and decodes superimposed communication signals from the local power grid 109. The third power line adapter 117 is coupled between the third amusement device 16 and the local power grid 109. The third power line adapter 117 superimposes communication signals onto the local power grid 109 and decodes superimposed communication signals from the local power grid 109.

The first, second and third power line adapters 118, 120 and 117 can utilize any known communication protocol such as that used by modems, transport control protocol/internet protocol (TCP/IP), serial or parallel protocols, and the like, without departing from the invention. In short, any communication protocol could be utilized, standard or proprietary, as would be recognized by one skilled in the art, so long as the communication protocol is compatible with the amusement devices 14, 16, 19, either directly or by conversion.

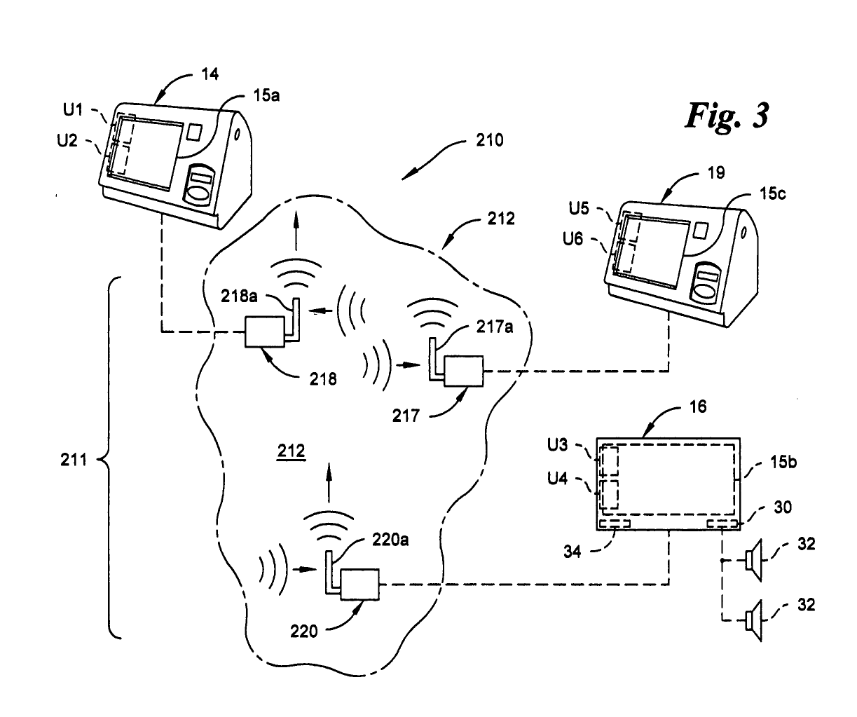

Referring to FIG. 3, there is shown a third preferred embodiment of an amusement device communication system 210 that includes a communication link 212 which links the first amusement device 14, the second amusement device 16 and the third amusement device 19 in a fashion similar to the first preferred embodiment, although the third preferred embodiment utilizes a wireless technique. The communication link 212 has a communication medium 213 and a wireless sub-system 211. In the presently preferred embodiment, the communication medium 213 amounts to the open space in the general vicinity and reflective surfaces thereabout because electromagnetic (EM) waves, such as radio waves, microwaves, and infrared (radiation) can modulate even in a vacuum. The wireless sub-system 211 includes a first wireless adapter 218, a second wireless adapter 220 and a third wireless adapter 217. Each of the wireless adapters 218, 220, and 217 includes a transmitting/receiving antenna 218a, 220a and 217a, respectively. The first wireless adapter 218 is coupled to the first amusement device 14. The first wireless adapter 218 encodes communication signals onto a wireless broadcast signal and decodes communication signals from the wireless broadcast signal. The second wireless adapter 220 is coupled to the second amusement device 16. The second wireless adapter 220 encodes communication signals onto the wireless broadcast signal and decodes communication signals from the wireless broadcast signal. The third wireless adapter 217 is coupled to the third amusement device 19. The third wireless adapter 217 encodes communication signals onto the wireless broadcast signal and decodes communication signals from the wireless broadcast signal. Preferably, the broadcast signal is in the range of radio frequency (RF), such as in the 900 MHz, 2.4 GHz, and 5 GHz bands and the like. The wireless broadcast signal may employ a frequency hopping spread spectrum technique (FHSS) which scatters packets of a data stream across a range of frequencies in a “hop sequence,” rather than using a single transmission frequency, thereby improving the bandwidth and the security of transmissions. It should also be noted that all EM waves suffer attenuation (reduction in intensity) as they pass through the atmosphere or through other material. Accordingly, repeaters or signal boosters (not shown) may be necessary additions to a particular amusement device communication system 210 installed in a large building, installed in multiple floors or installed in multiple buildings of a campus.

The first, second and third wireless adapters 218, 220 and 217 can utilize any known communication protocol such as that used by modems, TCP/IP, serial or parallel protocols, and the like without departing from the invention. As mentioned above regarding the second preferred embodiment, any communication protocol could be utilized, standard or proprietary, as would be recognized by one skilled in the art, so long as the communication protocol is compatible with the amusement devices 14, 16, 19, either directly or by conversion.

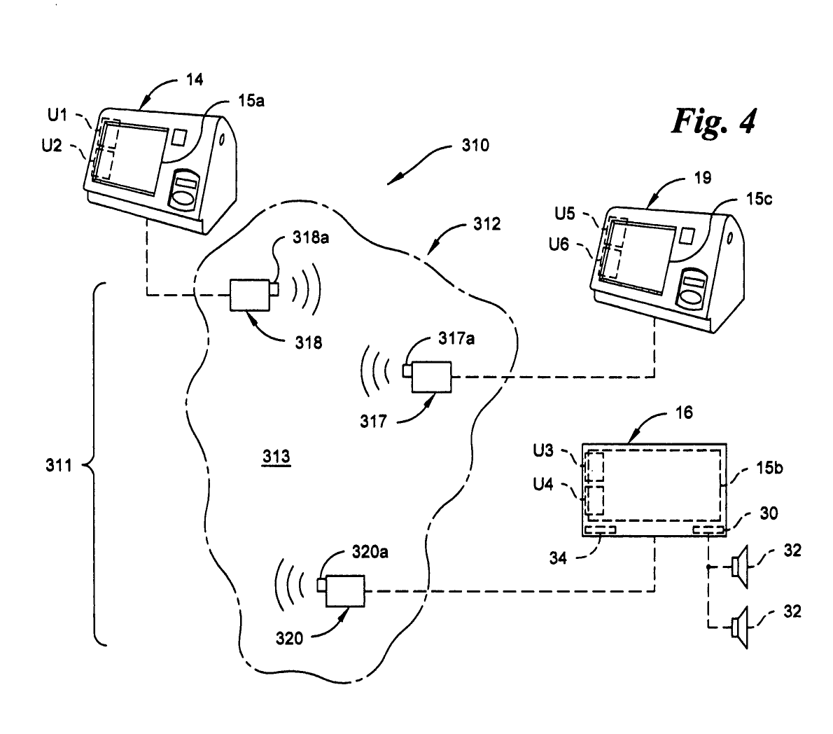

Referring to FIG. 4, there is shown a fourth preferred embodiment of an amusement device communication system 110 includes a communication link 312 which links the first amusement device 14, the second amusement device 16 and the third amusement device 19 in a fashion similar to the third preferred embodiment, although the fourth preferred embodiment utilizes an infrared (IR) technique. The communication link 312 has a communication medium 313 and an IR sub-system 311. In the presently preferred embodiment, the communication medium 313 amounts to the open space in the general vicinity and reflective surfaces thereabout. The IR sub-system 311 includes a first IR adapter 318, a second IR adapter 320 and a third IR adapter 317. Each of the IR adapters 318, 320, and 317 includes an IR transmitter/receiver 318a, 320a and 317a, respectively. The first IR adapter 318 is coupled to the first amusement device 14. The first IR adapter 318 encodes communication signals onto an IR broadcast signal and decodes communication signals from the IR broadcast signal. The second IR adapter 320 is coupled to the second amusement device 16. The second IR adapter 320 encodes communication signals onto the IR broadcast signal and decodes communication signals from the IR broadcast signal. The first IR adapter 318 is coupled to the first amusement device 14. The first IR adapter 318 encodes communication signals onto a IR broadcast signal and decodes communication signals from the IR broadcast signal. Preferably, the broadcast signal is in the infrared range of the electromagnetic spectrum, but the broadcast signal may also be in other ranges of the electromagnetic spectrum, such as the microwave region, without departing from the present invention. The IR broadcast signal may employ a frequency hopping spread spectrum technique (FHSS) which scatters packets of a data stream across a range of frequencies in a “hop sequence,” rather than using a single transmission frequency, thereby improving the bandwidth and the security of transmissions.

The first, second and third IR adapters 318, 320 and 317 can utilize any known communication protocol such as that used by modems, TCP/IP, serial or parallel protocols, and the like, without departing from the invention. As mentioned above regarding the third preferred embodiment, any communication protocol could be utilized, standard or proprietary, as would be recognized by one skilled in the art, so long as the communication protocol is compatible with the amusement devices 14, 16, 19, either directly or by conversion.

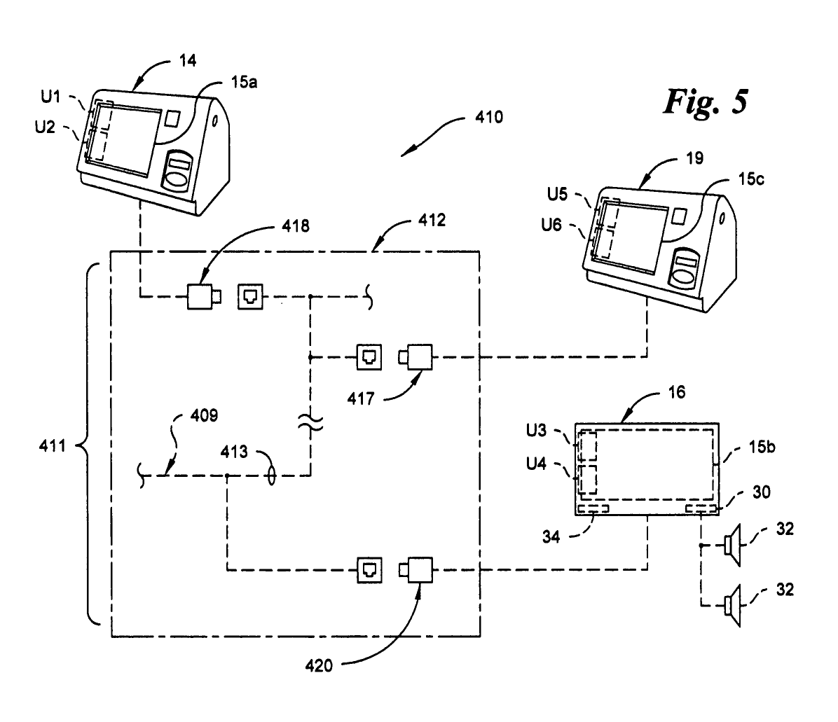

Referring to FIG. 5, there is shown a fifth preferred embodiment of an amusement device communication system 410 that includes a communication link 412 which links the first amusement device 14, the second amusement device 16 and the third amusement device 19 in a fashion similar to the second preferred embodiment. The amusement device communication system 410 includes a communication link 412 that has a communication medium 413 and a telephone line communication subsystem 411. The telephone line communication sub-system 411 includes a local telephone grid 409, a first telephone line adapter 418, a second telephone line adapter 420 and a third telephone line adapter 417. The local telephone grid 409 is configured to supply standard telephonic signals (i.e., low voltage at ˜24-48 VDC) to local telephones (not shown). In the presently preferred embodiment, the communication medium 413 amounts to the telephonic signal on the local telephone grid 409 because, as will be described hereafter, the first, second and third power line adapters 418, 420, and 417 superimpose signals onto the electrical voltage of the telephonic signal which acts as a carrier signal. But, the communication medium 413 could be construed as including the local telephone grid 409 without departing from the present invention. The first telephone line adapter 418 is coupled between the first amusement device 14 and the local telephone grid 409. The first telephone line adapter 418 superimposes communication signals onto the local telephone grid 409 and decodes superimposed communication signals from the local telephone grid 409. The second telephone line adapter 420 is coupled between the second amusement device 16 and the local telephone grid 409. The second telephone line adapter 420 superimposes communication signals onto the local telephone grid 409 and decodes superimposed communication signals from the local telephone grid 409. The third telephone line adapter 417 is coupled between the third amusement device 19 and the local telephone grid 409. The third telephone line adapter 417 superimposes communication signals onto the local telephone grid 409 and decodes superimposed communication signals from the local telephone grid 409.

Communications links such as 12, 112, 212, 312, and 412, which do not rely on dedicated network cabling, also make it possible to easily retrofit an existing site with inter-device communications for a variety of reasons, such as to allow device to device competition gaming, tournament games, remote management and the like, without requiring the installation of such dedicated network cabling through the walls, floors and ceilings. The absence of dedicated network cabling is a big advantage, as the time and expense associated with wiring and re-wiring is avoided. This is also a significant benefit in a dynamic environment where there is frequent reconfiguration of the floor space. Communications links such as 12, 112, 212, 312, and 412, which do not rely on dedicated network cabling, also make a great deal of sense in temporary quarters, such as at a game competition or a trade show, where costly cable and wire systems soon would have to be abandoned, and in older buildings where wires are difficult or impossible to run. Even in new installations, such amusement device communications systems 10, 110, 210, 310, and 410, make it possible to easily reconfigure the locations of amusement devices 14, 16, 19 at the site without the need to run a new network cable to the new location, providing even more flexibility in site setup. Furthermore, additional amusement devices 14, 16, 19 may be added to the network without the need for an electrician or technician by merely plugging the new amusement device 14, 16, 19 into a power source.

From the foregoing it can be seen that the present invention comprises an amusement device communication system using power lines, telephone lines or wireless communications. It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. An amusement device communication system comprising:
(a) a communication link having a communication medium and a power line communication subsystem;
(b) a first amusement device having a video touchscreen; and
(c) a second amusement device having a controller and a memory, the second amusement device being coupled to the first amusement device by the communication link, the first amusement device communicating with the second amusement device using the communication medium,
the power line communication sub-system including:
a local power grid configured to supply electrical power to local devices;
a first power line adapter coupled between the first amusement device and the local power grid, the first power line adapter superimposing communication signals onto the local power grid and decoding superimposed communication signals from the local power grid; and
a second power line adapter coupled between the second amusement device and the local power grid, the second power line adapter superimposing communication signals onto the local power grid and decoding superimposed communication signals from the local power grid.

2. The amusement device communication system according to claim 1, wherein the second amusement device includes an audio output, the memory being configured to store and retrieve music files, the controller of the second amusement device being configured to access the memory to retrieve one of the music files and output the retrieved music file to the audio output.

3. The amusement device communication system according to claim 2, wherein the second amusement device further includes a video output, the memory being configured to store and retrieve multimedia files, the controller of the second amusement device being configured to access the memory to retrieve one of the multimedia files and output the retrieved multimedia file to both the audio and video outputs.

4. The amusement device communication system according to claim 1, wherein the second amusement device includes a video touchscreen.

5. The amusement device communication system according to claim 1, further comprising:
(d) a plurality of other amusement devices each having a video touchscreen and each being coupled to the second amusement device by the communication link, the plurality of amusement devices communicating with the second amusement device using the communication medium.

6. The amusement device communication system according to claim 1, wherein the local power grid supplies 120 VAC, 60 Hz, single phase electrical power.

7. The amusement device communication system according to claim 1, wherein the local power grid supplies 230 VAC, 50 Hz, single phase electrical power.

8. An amusement device communication system comprising:
(a) a communication link having a communication medium and a wireless sub-system;
(b) a first amusement device having a video touchscreen; and
(c) a second amusement device having a controller and a memory, the second amusement device being coupled to the first amusement device by the communication link, the first amusement device communicating with the second amusement device using the communication medium,
the wireless sub-system including:
a first wireless adapter coupled to the first amusement device, the first wireless adapter encoding communication signals onto a wireless broadcast signal and decoding communication signals from the wireless broadcast signal; and
a second wireless adapter coupled to the second amusement device, the second wireless adapter encoding communication signals onto the wireless broadcast signal and decoding communication signals from the wireless broadcast signal.

9. The amusement device communication system according to claim 8, wherein the broadcast signal is in the range of one of radio frequency (RF), infrared (IR) and microwave.

10. An amusement device communication system comprising:
(a) a communication link having a communication medium and a telephone line communication subsystem;
(b) a first amusement device having a video touchscreen; and
(c) a second amusement device having a controller and a memory, the second amusement device being coupled to the first amusement device by the communication link, the first amusement device communicating with the second amusement device using the communication medium,
the telephone line communication sub-system including:
a local telephone grid configured to supply standard telephonic signals to local telephones;
a first telephone line adapter coupled between the first amusement device and the local telephone grid, the first telephone line adapter superimposing communication signals onto the local telephone grid and decoding superimposed communication signals from the local telephone grid; and
a second telephone line adapter coupled between the second amusement device and the local telephone grid, the second telephone line adapter superimposing communication signals onto the local telephone grid and decoding superimposed communication signals from the local telephone grid.

11. An amusement device communication system comprising:
(a) a communication link having a communication medium and a power line communication subsystem;
(b) first and third amusement devices, each having a video touchscreen and a controller; and
(c) a second amusement device having an audio output, a controller and a memory configured to store and retrieve music files, the second amusement device being coupled to the first and third amusement devices by the communication link, the first and third amusement devices communicating with the second amusement device using the communication medium, the video touchscreen of the first and third amusement devices each being configured to access the controller of the second amusement device to cause the controller to retrieve one of the music files and output the retrieved music file to the audio output of the second amusement device,
the power line communication sub-system including:
a local power grid configured to supply electrical power to local devices;
a first power line adapter coupled between the first amusement device and the local power grid, the first power line adapter superimposing communication signals onto the local power grid and decoding superimposed communication signals from the local power grid;
a second power line adapter coupled between the second amusement device and the local power grid, the second power line adapter superimposing communication signals onto the local power grid and decoding superimposed communication signals from the local power grid; and
a third power line adapter coupled between the third amusement device and the local power grid, the third power line adapter superimposing communication signals onto the local power grid and decoding superimposed communication signals from the local power grid.

12. An amusement device communication system comprising:
(a) a communication link having a communication medium and a wireless communication subsystem;
(b) first and third amusement devices, each having a video touchscreen and a controller; and
(c) a second amusement device having an audio output, a controller and a memory configured to store and retrieve music files, the second amusement device being coupled to the first and third amusement devices by the communication link, the first and third amusement devices communicating with the second amusement device using the communication medium, the video touchscreen of the first and third amusement devices each being configured to access the controller of the second amusement device to cause the controller to retrieve one of the music files and output the retrieved music file to the audio output of the second amusement device,
the wireless communication sub-system including:
a first wireless adapter coupled to the first amusement device, the first wireless adapter encoding communication signals onto a wireless broadcast signal and decoding communication signals from the wireless broadcast signal;
a second wireless adapter coupled to the second amusement device, the second wireless adapter encoding communication signals onto the wireless broadcast signal and decoding communication signals from the wireless broadcast signal; and
a third wireless adapter coupled between the third amusement device and the local power grid, the third wireless adapter encoding communication signals onto the wireless broadcast signal and decoding communication signals from the wireless broadcast signal.

13. An amusement device communication system comprising:
(a) a communication link having a communication medium and a telephone line communication subsystem;
(b) first and third amusement devices, each having a video touchscreen and a controller; and
(c) a second amusement device having an audio output, a controller and a memory configured to store and retrieve music files, the second amusement device being coupled to the first and third amusement devices by the communication link, the first and third amusement devices communicating with the second amusement device using the communication medium, the video touchscreen of the first and third amusement devices each being configured to access the controller of the second amusement device to cause the controller to retrieve one of the music files and output the retrieved music file to the audio output of the second amusement device,
the telephone line communication sub-system including:
a local telephone grid configured to supply standard telephonic signals to local telephones;
a first telephone line adapter coupled between the first amusement device and the local telephone grid, the first telephone line adapter superimposing communication signals onto the local telephone grid and decoding superimposed communication signals from the local telephone grid;
a second telephone line adapter coupled between the second amusement device and the local telephone grid, the second telephone line adapter superimposing communication signals onto the local telephone grid and decoding superimposed communication signals from the local telephone grid; and
a third telephone line adapter coupled between the third amusement device and the local telephone grid, the third telephone line adapter superimposing communication signals onto the local telephone grid and decoding superimposed communication signals from the local telephone grid.
